(19) United States
(12) Patent Application Publication
(10) Pub. No.: US 2012/0173131 A1
(43) Pub. Date: Jul. 5, 2012

(54) Airport Demand Management Method

(75) Inventor: Michael Christopher Brennan, Reston, VA (US)

(73) Assignee: Metron Aviation, Inc., Dulles, VA (US)

(21) Appl. No.: 12/985,336

(22) Filed: Jan. 5, 2011

(51) Int. Cl. G08G 5/00; G08G 5/06

(52) U.S. Cl. 701/120

(57) ABSTRACT

A method is presented here for mitigation of airport congestion problem by manipulating flight arrival times to coincide with expected departure times in order to keep airport demand under a specific limit and optimize utilized capacity of an airport. In one example, a threshold is defined which is related to the airport surface capacity to represent airport's tolerance for accumulation. At the time the congestion problem is overcome, the accumulation rate is not positive. In another example, a threshold is defined which is related to the airport facilities available to a specific carrier and is applied to the flights operated by that carrier.

### BACKGROUND OF THE INVENTION

Airport surface and gate congestion is a major cause of delays in air transportation. Three factors contribute to the flow regime at airports: the rate at which aircraft leave airports (departure rate), the rate at which aircraft enter airports (arrival rate) and the capacity of the airport, both total surface capacity and the gate capacity of individual flight operators. Being dependent on current demand and uncontrollable conditions, arrival and departure flights are neither organized nor synchronous. That is, although the arrival and departure numbers are equal in the statistical sense, their temporal numbers do not match and the difference needs to be accumulated temporarily. However this temporary accumulation requirement must be accommodated by the airport facilities and has the potential to exceed the available resources.

### SUMMARY OF THE INVENTION

In one embodiment, this invention aims addresses the issue of airport congestion by managing arrival and departure flights so that the accumulation of the aircraft in the airports remains within manageable thresholds. This is accomplished by delaying the departure of flights planning to arrive at the airport just long enough to keep the accumulation of flights at the airport less than the specified thresholds. In one embodiment, in which the total airport is the constraining factor, the threshold is the surface capacity of the airport and all flights are considered. In another embodiment, in which the facilities available to a single flight operator such as an airline are the constraining factor, the threshold is the ground capacity of the carrier including its gates and only flights controlled by the operator are considered.

### BRIEF DESCRIPTION OF THE DRAWINGS

FIG. 1 is a diagram of the overall flow showing the sequence of steps executed at regular intervals during the operating day to keep the airport flight count within the capacity threshold.

FIG. 2 is a flow diagram showing how gate pushback times and airport constraints are used to estimate when flights will depart the airport.

FIG. 3 is a flow diagram showing how the first flight that causes the flight count at the airport to exceed the threshold is identified.

FIG. 4 is a flow diagram showing how the departure and arrival time of the flight identified in FIG. 3 are adjusted to maintain the airport demand within the capacity.

FIG. 5 is a diagram of the overall flow showing the sequence of steps executed at regular intervals by a flight operator during the operating day to keep the number of flights the operator must manage at the airport below a threshold.

FIG. 6 is a flow diagram showing how the first flight that causes the flight count for the operator to exceed the threshold is identified.

FIG. 7 is a flow diagram showing how the departure and arrival time of the flight identified in FIG. 7 is adjusted to maintain the airport demand within the capacity.

FIG. 8 is a schematic diagram showing how an example of the present invention mitigates an example problem in which demand exceeds capacity.

### DETAILED DESCRIPTION OF THE PREFERRED EMBODIMENTS

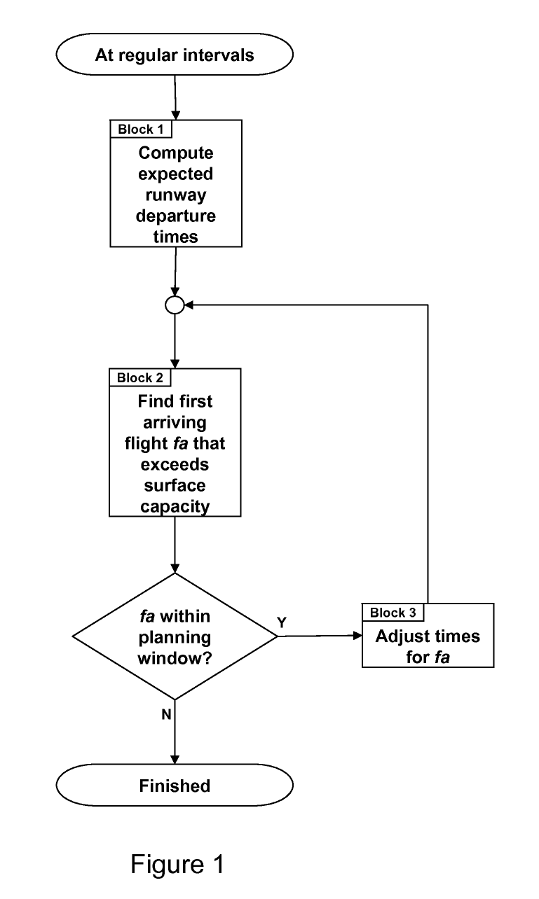

In one embodiment of the present invention, as illustrated in FIG. 1, the total flight count on the surface of the airport is kept below a threshold. In this embodiment the runway departure time for each planned departure flight is estimated (details presented in the diagram for Block 1). Then the future flight operations (arrivals and departures) are evaluated to see if any flight will cause the accumulated airport flight count to exceed the surface capacity within a reasonable planning window (details presented in the diagram for Block 2). If a flight will, then the operating times for the flight are adjusted to keep the airport within capacity (details presented in the diagram for Block 3) and the revised plans are re-evaluated to see if capacity is exceeded by a later flight. This process iterates until no more problems are predicted within a reasonable planning window.

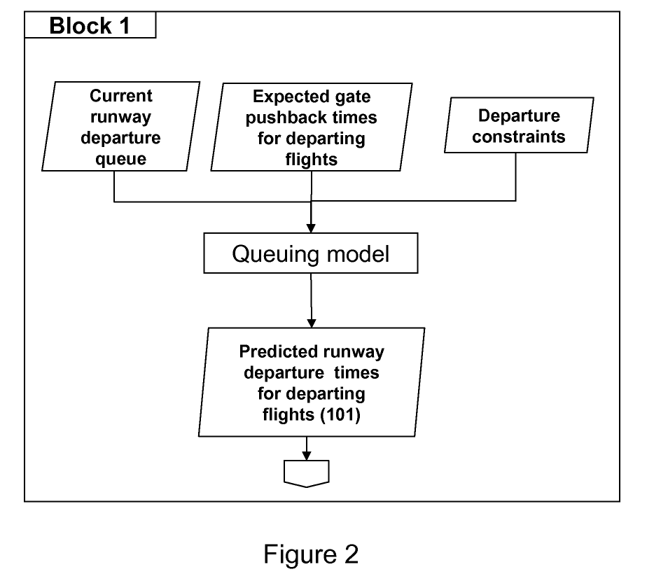

In one embodiment, as in Block 1 of FIG. 2, the current state of flights awaiting runway departure, the expected gate pushback times of future flights, and all airport departure constraints are entered into a departure queuing model (simple or complex, not presented here) to predict when each flight will leave the airport surface and reduce the projected flight count.

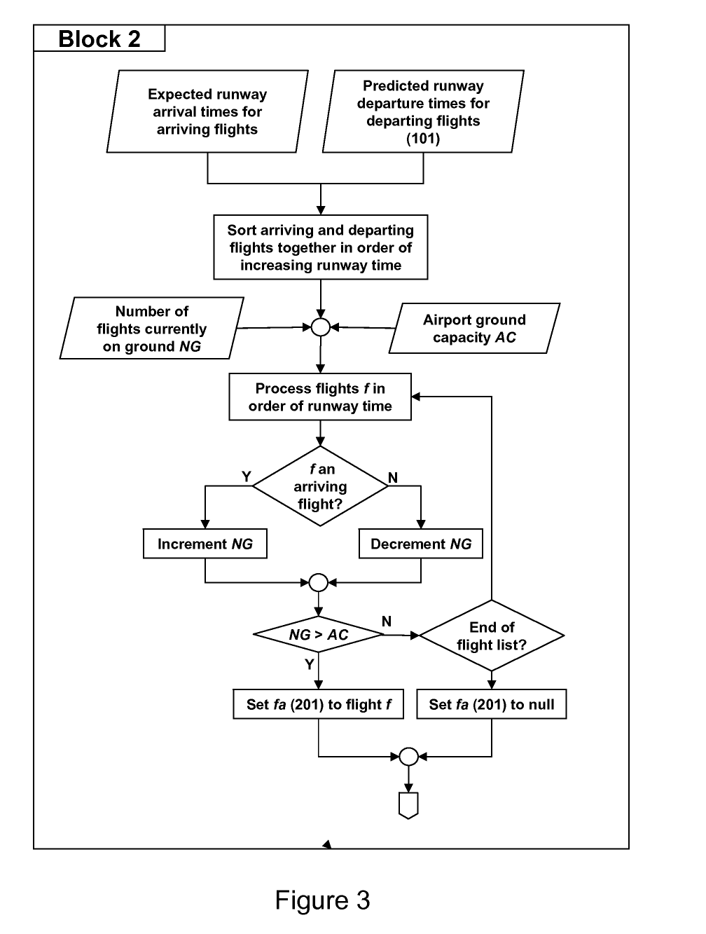

In a further embodiment of the present invention, as shown in Block 2 of FIG. 3, the future flight operations at the airport (planned arrivals and predicted departures) are combined and sorted by event time (runway arrival time for arrivals and runway departure time for departures). The current flights on the ground NG are combined with the future operations to determine whether future counts of flights on the ground exceed the airport capacity AC. This occurs by stepping through each flight event in time order and adjusting the expected flight count up or down depending on the type of operation. If any flight f causes the count to exceed the capacity then that flight is returned as flight fa.

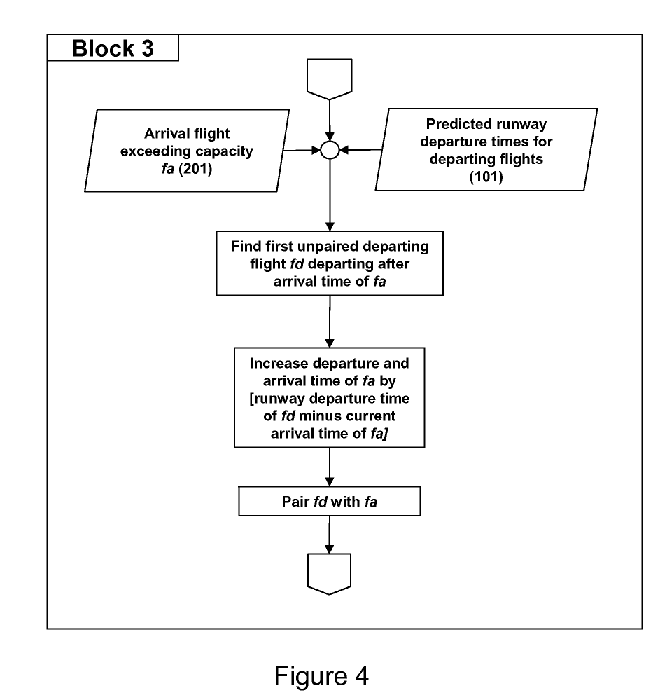

In one embodiment, as depicted Block 3 in FIG. 4, the flight fa is shifted later to have it arrive at a time corresponding to another flight leaving the airport. This is accomplished by finding the first departing flight with a predicted runway departure time after the planned arrival time of fa that has not already been paired with another arrival, meaning another arriving flight has not been set to arrive to use the surface capacity freed by the departing flight. When this flight, fd, has been found the arrival time of fa is shifted to match the departure time of fd, and the departure time of fa at its departure airport is shifted the same amount. That is, fa is assigned an operating delay sufficient to have it a arrive as fd departs.

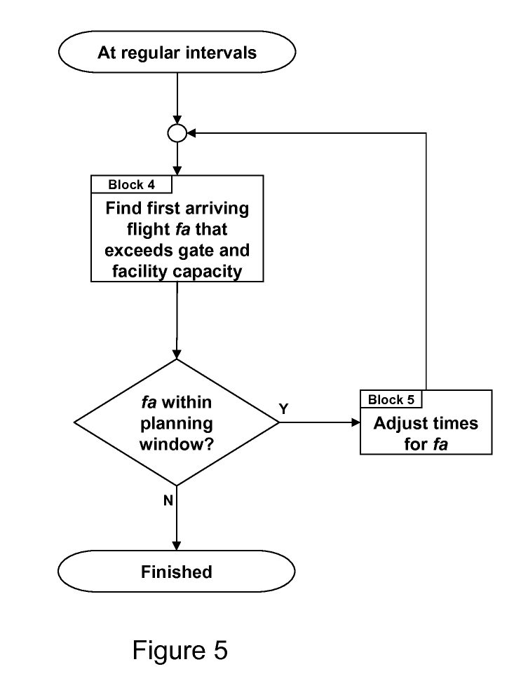

In another embodiment of the present invention, as illustrated in FIG. 5, the total count of flights controlled by a single operator at the airport is kept below a threshold. In this embodiment the future flight operations (runway arrivals and gate pushbacks) are evaluated to see if any flight will push the number of flights controlled by the operator over the maximum capacity of the operator's gates and facilities within a reasonable planning window (details presented in the diagram for Block 4). If a flight will, then the operating times for the flight are adjusted to keep the flight count within capacity (details presented in the diagram for Block 5) and the revised plans are re-evaluated to see if capacity is exceeded by a later flight. This process iterates until no more problems are predicted within a reasonable planning window.

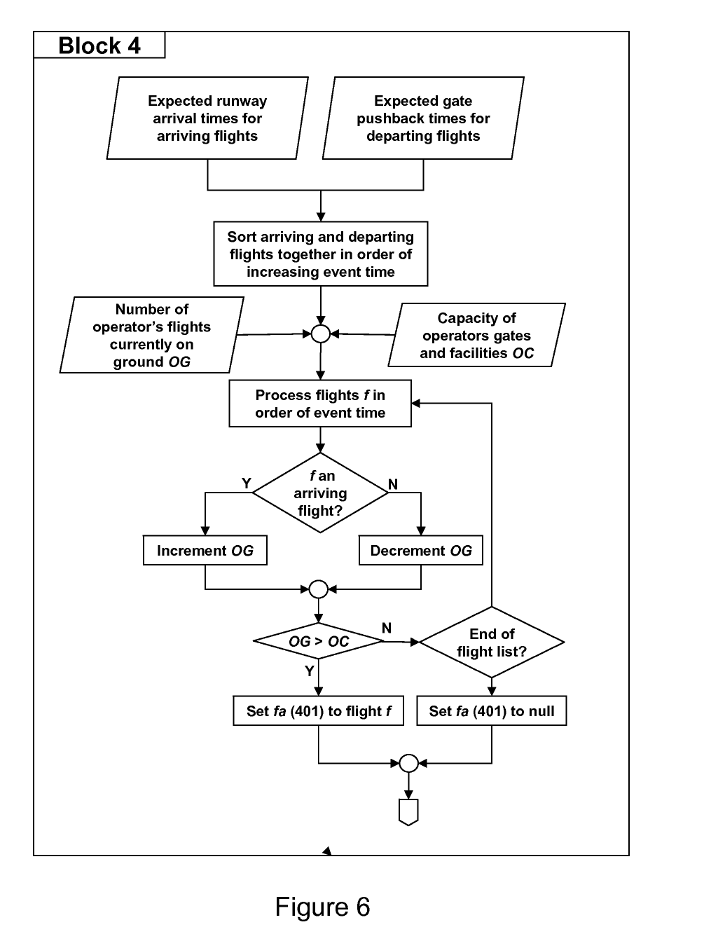

In one embodiment of the present invention, as shown in Block 4 of FIG. 6, the future flight operations at the airport (planned arrivals and departures) are combined and sorted by event time. The event of interest for departing flights is the planned gate pushback time. The event of interest for an arriving flight is the planned runway arrival time plus a positive or negative buffer to reflect details of taxi and gate operations at the airport. The flights controlled by the operator currently on the ground OG are combined with the future operations to determine whether future counts of flights exceed the operator gate and facility capacity OC. This occurs by stepping through each flight event in time order and adjusting the expected flight count up or down depending on the type of operation. If any flight f causes the count to exceed the capacity then that flight is returned as flight fa [401].

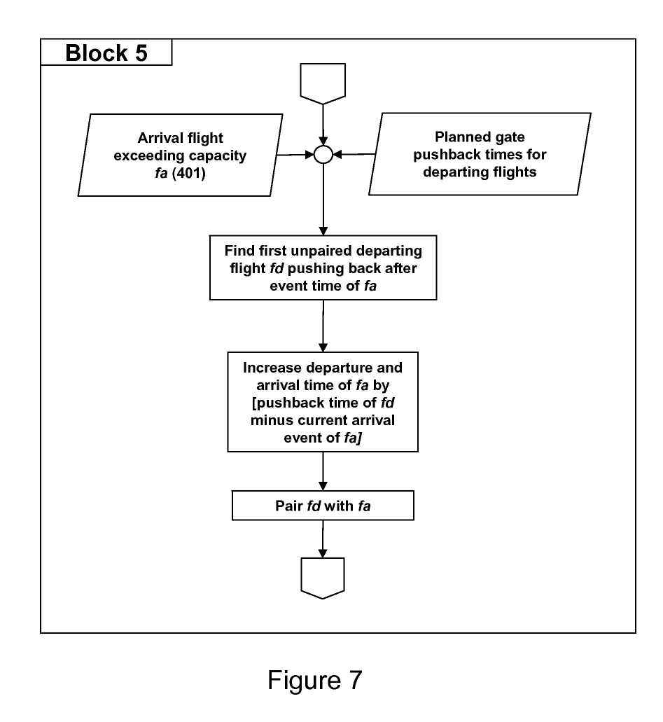

In one embodiment, as depicted Block 5 in FIG. 7, the flight fa [401] is shifted later to have it arrive at a time corresponding to another flight controlled by that operator pushing back from the gate. This is accomplished by finding the first departing flight with a planned gate pushback time after the planned event time of fa that has not already been paired with another arrival, meaning another arriving flight has not been set to arrive to use the gate capacity freed by the departing flight. When this flight fd has been found the arrival time of fa is shifted to match the pushback time of fd plus the buffer from Block 4, and the departure time of fa at its departure airport is shifted the same amount. That is, fa is assigned an operating delay sufficient to have it arrive to use the gate facilities fd frees up when pushing back.

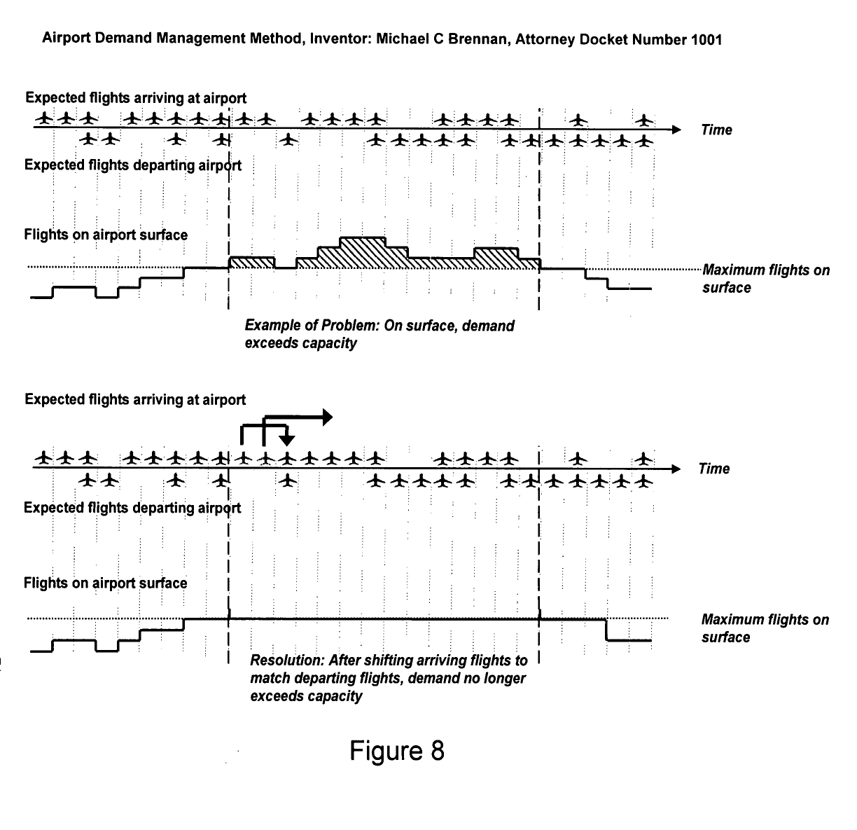

FIG. 8 further demonstrates an embodiment of the present invention on how times of flights are managed to prevent airport congestion.

In one embodiment a mathematical algorithm for airport demand management, comprises the following elements: a threshold; a planned times database; an updated times database; a realization database; planned departure times, planned pushback times, and planned arrival times in said planned times database; total number of aircraft on ground and en-route time in said realization database; updated arrival times, updated gate pushback times, updated departure times in calculated actual gate pushback times, calculated runway departure times, constraints in a constraints database; and a queuing model. In one embodiment, the queuing model dynamically calculates runway departure times considering the constraints in the constraints database for a plurality of flights.

In an alternative embodiment, the method comprises a buffer time and assigned arrival time slots, and the assigned arrival time slots and planned departure times have a time difference equal to the buffer time.

In a further example of this invention, the algorithm further comprises a saturation time which is dynamically calculated as the time at which the rate of accumulation of aircraft on surface of the airport is positive and the current realization of number of aircraft on surface equals or exceeds that threshold.

In another embodiment, the method further comprises assigned arrival time slots calculated for any flight with the planned arrival times after the above mentioned saturation time.

In one embodiment, the method further comprises an en-route time period and an updated departure time. The updated assigned departure time is determined by subtracting the en-route time period from the assigned arrival time slot for each flight.

In an embodiment of the method, at any time, the updated departure times are determined for all flights with their planned arrival times preceding their assigned arrival time slots. This way, subsequently, a new total number of aircraft on ground is calculated at any time, and preceding operations leading to this point are repeated using this “new total number of aircraft on ground” replacing the old “total current number of flights on ground,” until the new total number of aircraft on ground is less than the threshold.

In one embodiment, the constraints are related to departure. In another, the constraints are related to gate services. In a further embodiment, a new “total number of aircraft awaiting gates or at gates” are calculated instead of “new total number of aircraft on ground.”

A system, an apparatus, a device, or an article of manufacture comprising one of the following items is an example of the invention: computers, monitors, displays, indicators, graphical user interfaces (GUI), topology, sensors, tools or systems measuring the count and speed of aircraft, timers, global positioning systems (GPS), radars, air traffic control equipment or facilities, air traffic logging equipment, configurations, threshold settings, filters, quick access controls, objects, navigation, navigation tools, user input, semantic rules, semantic matching modules, tower operations tools, electronic flight data management equipment, files, databases, NTML database, enhanced traffic management system (ETMS), NextGen air-ground communication system (NEXCOM), queuing models solvers, mice, keyboards, similarity information, applying the method mentioned above, for the purpose of the current invention or managing airport demand based on continuous rebalancing of the incoming and outgoing traffic from an airport.

Any variations of the above teaching are also intended to be covered by this patent application.

1. A mathematical algorithm for airport demand management, said mathematical algorithm comprising:
a threshold;
a planned times database;
an updated times database;
a realization database;
planned departure times, planned pushback times, and planned arrival times in said planned times database;
total number of aircraft on ground and en-route time in said realization database;
updated arrival times, updated gate pushback times, updated departure times in calculated actual gate pushback times,
calculated runway departure times,
constraints in a constraints database; and
a queuing model;
wherein said queuing model dynamically estimates said calculated actual gate pushback times or said calculated runway departure times considering said constraints in said constraints database for a plurality of flights.

2. A method as recited in claim 1, further comprising a buffer time and assigned arrival time slots, wherein said assigned arrival time slots and said planned departure times have a time difference of less than or equal to said buffer time.

3. A method as recited in claim 2, further comprising a saturation time wherein said saturation time is dynamically calculated as the time at which the rate of accumulation of aircraft on surface of the airport is positive and said current realization of number of aircraft on surface equals or exceeds said threshold.

4. A method as recited in claim 3, wherein said assigned arrival time slots are calculated for any flight with said planned arrival times after said saturation time.

5. A method as recited in claim 4, further comprising an en-route time period and an updated departure time, wherein said updated departure time is determined by subtracting said en-route time period from said assigned arrival time slot for each flight.

6. A method as recited in claim 5, wherein at any time, said updated departure times are determined for all flights with their said planned arrival times preceding their said assigned arrival time slots, wherein subsequently, a new total number of aircraft on ground is calculated at any time, and wherein operations of claim 5 are repeated using said new total number of aircraft on ground replacing said total current number of flights on ground, until said new total number of aircraft on ground is less than said threshold.

7. A method as recited in claim 6, wherein said constraints are related to departure.

8. A method as recited in claim 6, wherein said constraints are specific to certain carriers or applied to flights operated by that carrier.

9. A method as recited in claim 6, wherein said constraints related to departure and are either specific to certain carriers or applied to flights operated by that carrier.

10. A method as recited in claim 6, wherein new total number of aircraft awaiting gates or at gates are calculated instead of said new total number of aircraft on ground.

11. A method as recited in claim 10, wherein said constraints are related to gate services.

12. A method as recited in claim 10, wherein said constraints are specific to certain carriers or applied to flights operated by that carrier.

13. A method as recited in claim 10, wherein said constraints are related to gate services and are either specific to certain carriers or applied to flights operated by that carrier.
